(19) United States
(12) Patent Application Publication
(10) Pub. No.: US 2020/0201014 A1
(43) Pub. Date: Jun. 25, 2020

(54) MICROSCOPE AND MICROSCOPE ILLUMINATION METHOD

(71) Applicant: Leica Microsystems CMS GmbH, Wetzlar (DE)

(72) Inventors: Benjamin Deissler, Butzbach (DE); Arnold Mueller-Rentz, Brechen (DE)

(21) Appl. No.: 16/612,777

(22) PCT Filed: May 16, 2018
(86) PCT No.: PCT/EP2018/062663

§ 371 Date: Nov. 12, 2019

(30) Foreign Application Priority Data
May 16, 2017 (DE) 10 2017 110 638.3

(51) Int. Cl. G02B 21/14; G02B 21/16; G02B 21/02; G02B 21/24

(52) U.S. Cl. CPC G02B 21/14; G02B 21/241; G02B 21/025; G02B 21/16

(57) ABSTRACT

A microscope for examining a sample in phase contrast transmitted light illumination and/or in fluorescence reflected light illumination includes a phase contrast transmitted light illumination device, a fluorescence reflected light illumination device and an objective with a phase ring. The phase contrast transmitted light illumination device comprises a transmitted light illumination source and a transmitted light illumination optical unit with a ring stop. The ring stop comprises a light-opaque inner stop region which is surrounded by an at least partly light-transmissive ring-shaped region. The fluorescence reflected light illumination device comprises a reflected light illumination source and a reflected light illumination optical unit. A fluorescence reflected light illumination beam path produced by the fluorescence reflected light illumination device will lie, in terms of its cross section, within the inner stop region of the ring stop o after passing through an object plane of the microscope.

### CROSS-REFERENCE TO PRIOR APPLICATIONS

This application is a U.S. National Stage Application under 35 U.S.C. § 371 of International Application No. PCT/EP2018/062663 filed on May 16, 2018, and claims benefit to German Patent Application No. DE 10 2017 110 638.3 filed on May 16, 2017. The International Application was published in German on Nov. 22, 2018 as WO 2018/210906 A1 under PCT Article 21(2).

### FIELD

The present invention relates to a microscope and a microscope illumination method, more particularly a microscope for examining a sample in phase contrast transmitted light illumination and subsequently or alternately or else simultaneously in fluorescence reflected light illumination, and a corresponding microscope illumination method.

### BACKGROUND

In cytodiagnostics and in pathology, stained samples are usually examined with a microscope in transmitted light bright field illumination. The color of the sample examined by microscope is an important criterion for the diagnosis. The color of the sample is of lesser importance in other microscopic examinations, for example with contrasting methods such as phase contrast or differential interference contrast (DIC) methods. Such contrasting methods are usually used to examine non-stained samples, which present themselves as predominantly transparent in transmitted light bright field microscopy. Then, the contrasting methods serve to make phase properties of the sample visible.

In phase contrast microscopy, a so-called phase ring is installed in or at the microscope objective and a ring stop is installed in the condenser optical unit of the transmitted light illumination device. The ring stop, also referred to as a light ring, restricts the incidence of light on the sample to a certain angle of incidence range. The phase ring brings about a phase shift of the incident light through 90°. By way of light diffraction, for example at cell structures, light passing through the object is deflected in such a way that the majority thereof does not pass through the phase ring. However, the diffraction in the sample also brings about a phase shift that is dependent on the refractive index. The phase difference between diffracted object light and background light passing through the phase ring causes interference in the image plane. Appropriate dimensioning of the phase ring thus allows the object to be presented, for example, in dark in front of a bright background (positive phase contrast). Imaging with negative phase contrast is also possible.

Fluorescence microscopy represents a further known examination method. Here, the sample to be examined is illuminated by means of a reflected light illumination beam path, which passes through a so-called excitation filter. The excitation light leads to fluorescence light in the object marked with fluorescing substances, with the emitted fluorescence light determining the arising microscope image of the sample. The specified microscopy methods have been known per se for a relatively long time. Reference is made to the available prior art in respect of further details.

Halogen lamps, which were predominantly used in transmitted light microscopy in the past, are increasingly being replaced by solid-state light sources, e.g. light-emitting diodes (referred to as LEDs below), with their known advantages. These advantages include a higher light emission with lower electric power consumption, and a longer service life. White light LEDs are predominantly used for transmitted light illumination. Such solid-state light sources often exhibit luminescence upon excitation by an external light source. By way of example, this is the case for LEDs where a phosphor layer is used to generate certain spectral components (in particular white light LEDs, but also in the green spectral range, for example). In the case of microscopes that combine transmitted light illumination and fluorescence reflected light illumination, the solid-state light source used for the transmitted light illumination can be excited by the light source of the fluorescence reflected light illumination. This is because a large portion of the excitation light for the fluorescence excitation is able to passes through the sample and, from the latter, reaches the transmitted light illumination source via the transmitted light illumination axis. The luminescence light generated there on account of excitation is perceived as a disturbing background in the fluorescence image. This effect even occurs when the solid-state light source of the transmitted light illumination is deactivated.

In DE 10 2011 079 941 A1, this problem is treated in the context of a microscope for alternately or simultaneously examining a sample in transmitted light bright field illumination and reflected light fluorescence illumination. In order to avoid the specified luminescence light, an adaptation filter is introduced on the transmitted light illumination axis, said filter spectrally blocking from the fluorescence reflected light illumination the excitation light causing the luminescence. The adaptation filter can also remain on the transmitted light illumination axis in the case of a change to transmitted light bright field illumination since this allows the spectrum of a white light LED, which is used for example, to approximate the spectrum of a halogen lamp. However, according to this document, the removal of the adaptation filter from the illumination beam path of the transmitted light illumination in manual or motor-driven fashion is expedient when using a contrasting method such as phase contrast so that a higher luminous intensity is available for the chosen contrasting method. However, such a switchable adaptation filter has a complicated design, requires a relatively large installation space, is expensive to manufacture and, moreover, slow in switching.

The same disadvantages occur when using a blocking apparatus (e.g., a shutter) which is situated on the transmitted light illumination axis in switchable fashion.

By way of example, DE 10 2011 079 942 A1 proposes a switchable shutter to be necessarily activated or introduced on the transmitted light illumination axis when the reflected light fluorescence illumination is activated in order to prevent an excitation of the white light LED used as transmitted light bright field illumination source, with this shutter then necessarily being deactivated or pivoted away when the transmitted light bright field illumination is activated.

### SUMMARY

In an embodiment, the present invention provides a microscope for examining a sample in phase contrast transmitted light illumination and/or in fluorescence reflected light illumination. The microscope includes a phase contrast transmitted light illumination device, a fluorescence reflected light illumination device and an objective with a phase ring. The phase contrast transmitted light illumination device comprises a transmitted light illumination source and a transmitted light illumination optical unit with a ring stop. The ring stop comprises a light-opaque inner stop region which is surrounded by an at least partly light-transmissive ring-shaped region. The fluorescence reflected light illumination device comprises a reflected light illumination source and a reflected light illumination optical unit. The microscope is configured such that a fluorescence reflected light illumination beam path produced by the fluorescence reflected light illumination device will lie, in terms of its cross section, within the inner stop region of the ring stop of the phase contrast transmitted light illumination device after passing through an object plane of the microscope.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically shows the setup of a microscope for examining a sample in phase contrast transmitted light illumination and/or fluorescence reflected light illumination according to one embodiment of the invention,

FIG. 2 schematically shows a ring stop, as may be used in a microscope according to FIG. 1, and

FIG. 3 schematically shows the beam path of the fluorescence reflected light illumination in a microscope according to FIG. 1 according to one embodiment of the invention

### DETAILED DESCRIPTION

Embodiments of the present invention improve the examination of a sample using a microscope in phase contrast transmitted light illumination and/or in fluorescence reflected light illumination, wherein switchable elements can advantageously be avoided for suppressing disturbing luminescence.

According to embodiments of the invention, a microscope, the use of a ring stop in such a microscope and a method for microscope illumination are provided.

An embodiment of the invention is based on the discovery that a ring stop situated in the transmitted light illumination optical unit of the phase contrast transmitted light illumination device can be used to shield the transmitted light illumination source, which, as a rule, represents a solid-state light source, from incident radiation of the fluorescence reflected light illumination device.

A microscope according to an embodiment of the invention for examining a sample in phase contrast transmitted light illumination and/or in fluorescence reflected light illumination comprises a phase contrast transmitted light illumination device and a fluorescence reflected light illumination device, wherein the phase contrast transmitted light illumination device comprises a transmitted light illumination source, in particular a solid-state light source, in particular one or more LEDs, in particular one or more white light LEDs, and a transmitted light illumination optical unit, in particular a condenser optical unit, with a ring stop, wherein the ring stop (light ring) comprises a light-opaque inner stop region which is surrounded by an at least partly light-transmissive substantially ring-shaped region. The fluorescence reflected light illumination device comprises a reflected light illumination source and a reflected light illumination optical unit, in particular with a beam splitter. Furthermore, the microscope is equipped with an objective with a phase ring for the phase contrast transmitted light illumination. In order to avoid the luminescence by excitation of the transmitted light illumination light source, as explained at the outset, the microscope setup is chosen in such a way that, in terms of its cross section, the fluorescence reflected light illumination beam path produced by the fluorescence reflected light illumination device lies predominantly, but more particularly completely, within the inner stop region of the ring stop of the phase contrast transmitted light illumination device after passing through the object plane of the microscope—even if an object is situated there. This yields shadowing, more particularly complete shadowing, of the reflected light illumination beam path before it strikes the transmitted light illumination source following an entry into the phase contrast transmitted light illumination device.

The corresponding microscope setup can be obtained in various ways. Preferably, the transmitted light illumination optical unit comprises a condenser optical unit or a condenser or said transmitted light illumination optical unit consists of such a condenser optical unit or such a condenser, the ring stop being disposed in the back focal plane thereof. Preferably, the ring stop is securely disposed on the transmitted light illumination axis. Then, the remaining optical units present in the microscope, specifically the transmitted light illumination optical unit, reflected light illumination optical unit and objective, can be set individually, in combination or all together in such a way that the aforementioned shielding occurs in optimal fashion. “Settings” of the optical unit or of the objective should be understood to mean that lenses situated there are altered in terms of their focal length and/or such lenses are displaced along the optical axis. Advantageously, the reflected light illumination optical unit present, which is also referred to as a fluorescence axis, is set in such a way that, in terms of its cross section, the fluorescence reflected light illumination beam path comes to lie completely within the inner stop region of the ring stop when passing through the object plane—both when an object is situated there and when an object is absent. The reflected light illumination optical unit contains optical elements—from a single lens in the simplest case to a complex system of lenses, filters, stops, etc. The function of the reflected light illumination optical unit is to guide as much light as possible from the fluorescence reflected light illumination source to the sample and to ensure a uniform illumination of the sample there. A suitable setting of this reflected light illumination optical unit, in particular of its focal length and/or magnification, can ensure that light passing through the object plane that reaches into the transmitted light illumination optical unit is prevented there from further propagation in the direction of the transmitted light illumination source by the ring stop situated in said transmitted light illumination optical unit.

If different objectives and/or different light rings are used with the microscope, the internal diameter of the phase ring will generally differ between the objectives. If the fluorescence reflected light optical unit is designed in such a way that it is alterable in terms of focal length and/or magnification, the size of the light cone at the position of the phase ring can be chosen in such a way that the preferably entire light cone lies in the inner region of the phase ring (and consequently also in the inner region of the light ring).

An embodiment of the invention furthermore provides for the use of a specified ring stop in a microscope of the aforementioned type for the purposes of avoiding the excitation of luminescence in the transmitted light illumination source by light of the fluorescence reflected light illumination source. In order to avoid repetition, reference in this respect is made to the explanations provided above in the context of the microscope according to an embodiment of the invention.

Finally, an embodiment of the invention provides a method for microscope illumination using a microscope of the aforementioned type, wherein the transmitted light illumination optical unit and/or the reflected light illumination optical unit and/or the objective of the microscope and/or the position of the ring stop on the transmitted light illumination axis is/are set in such a way that, in terms of its cross section, the fluorescence reflected light illumination beam path produced by the fluorescence reflected light illumination device lies within the inner stop region of the ring stop of the phase contrast transmitted light illumination device after passing through the object plane of the microscope. In respect of further configurations and advantages of the method according to embodiments of the invention, reference is made, once again, to the explanations provided above in the context of the microscope according to embodiments of the invention.

It is particularly advantageous if, in the case of a fixed position of the ring stop on the transmitted light illumination axis and a given setting of the transmitted light illumination optical unit and of the objective, the reflected light illumination optical unit is set in such a way that, in terms of its cross section, the fluorescence reflected light illumination beam path produced by the fluorescence reflected light illumination device lies completely within the inner stop region of the ring stop of the phase contrast transmitted light illumination device after passing through the object plane of the microscope.

It is furthermore advantageous if the reflected light illumination source is substantially imaged into the back focal plane of the objective, in which back focal plane the phase ring is also situated. This back focal plane is imaged by the microscope objective and the transmitted light illumination optical unit or the condenser into the back focal plane of the condenser, in which back focal plane the ring stop is situated. By suitably setting the reflected light illumination optical unit, the imaging of the reflected light illumination source can be chosen in such a way that the image thereof is smaller than the diameter of the inner stop region of the ring stop. To this end, in turn, the image of the reflected light illumination source situated in the back focal plane of the objective should lie within the diameter of an inner region of the phase ring. This inner region is the transparent region within the inner diameter of the phase ring.

Further advantages and configurations of embodiments of the invention arise from the description and the attached drawings.

It is understood that the features mentioned above and the features yet to be explained below can be used not only in the combination specified in each case, but also in other combinations or on their own, without departing from the scope of the present invention.

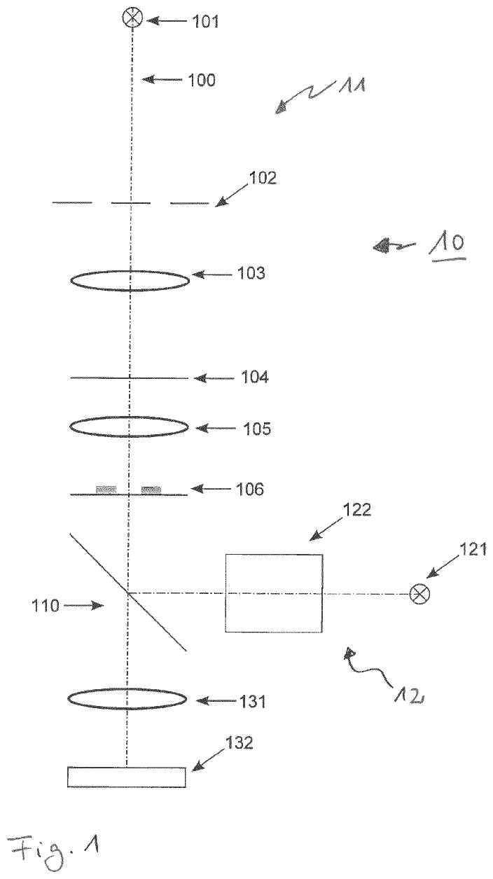

The microscope schematically illustrated in FIG. 1 comprises a phase contrast transmitted light illumination device 11 and a fluorescence reflected light illumination device 12. As essential elements, the phase contrast transmitted light illumination device 11 comprises a transmitted light illumination source 101, which constitutes a solid-state light sources such as a white light LED in this exemplary embodiment, and a transmitted light illumination optical unit 103, which constitutes a condenser in this exemplary embodiment. The ring stop 102, which is also referred to as a light ring, is situated in the back focal plane of the condenser.

For the purposes of examining a sample in phase contrast transmitted light illumination, the microscope 10 comprises an objective 105 with a phase ring 106.

For the purposes of examining a sample in fluorescence reflected light illumination, the microscope 10 comprises the aforementioned fluorescence reflected light illumination device 12, which, as essential elements, contains a reflected light illumination source 121 and a reflected light optical unit 122. A beam splitter 110 disposed on the optical axis of the objective 105 is illustrated schematically and guides the fluorescence reflected light illumination beam path in the direction of the objective 105 and object plane 104. Fluorescence light emitted by a sample in the object plane 104 reaches the tube 131 of the microscope 10 via the objective 105 and the beam splitter 110. In a manner known per se, an eyepiece and/or a camera 132 can be disposed downstream of the tube 131. Moreover, the beam splitter 110 prevents light of the fluorescence reflected light illumination source 121, which is reflected at components of the microscope such as the objective 105, from reaching the direction of the tube 131.

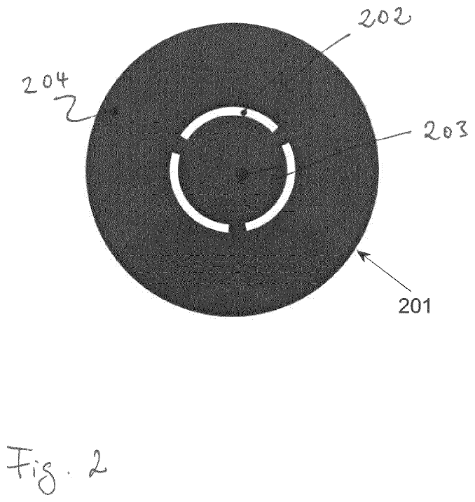

FIG. 2 shows the ring stop 102 of FIG. 1 schematically in a plan view. The light-opaque inner stop region 203, which is surrounded by an at least partly light-transmissive substantially ring-shaped region, is clearly visible. The ring-shaped region 202 is adjoined, in turn, by a ring-shaped light-opaque region 204. This geometry of the ring stop 201 ensures that the sample is illuminated under certain aperture angles when the ring stop is introduced into the back focal plane of the condenser 103. As explained at the outset, this, in conjunction with the phase ring 106, allows an object to be imaged and examined in phase contrast.

In addition to phase contrast, the microscope 10 illustrated in FIG. 1 also facilitates the imaging or examination of an object in fluorescence reflected light illumination. As explained at the outset, some of the fluorescence reflected light illumination passes through an object situated in the object plane 104 into the phase contrast transmitted light illumination device 11. Thus, some of the fluorescence reflected light illumination there is guided via the condenser to the transmitted light illumination source 101. In principle, this is even the case should a ring stop 102 be disposed in the back focal plane of the condenser 103 as this ring stop has light-transmissive regions. Light of the reflected light illumination source 121 striking the transmitted light illumination source 101 leads to luminescence when use is made of solid-state light sources, as explained in detail at the outset, said luminescence, in turn, being noticeable as disturbing background illumination when recording images in fluorescence reflected light illumination. This can be prevented by virtue of choosing the microscope setup according to FIG. 1 such that, in terms of its cross section, the fluorescence reflected light illumination beam path produced by the fluorescence reflected light illumination device 12 lies within the inner stop region 203 of the ring stop 102 after passing through the object plane 104. In this way, the fluorescence reflected light illumination is blocked before reaching the transmitted light illumination source 101. It is expedient if the entire cross section comes to lie within the inner stop region 203.

The measures set forth below are suitable for this effect of shielding or blocking. In principle, it is possible for all possible adjustable optical elements in the microscope to be set, specifically the transmitted light illumination optical unit 103, the microscope objective 105 and the reflected light illumination optical unit 122, which may each consist of a single lens up to a complex system of lenses, filters, stops, etc. Often, these optical units 103, 105 and 122 are adjustable in terms of their focal length. Additionally or alternatively, individual lenses of these optical units 103, 105, 122 can be displaced along the respective optical axes. Most expediently, the reflected light illumination optical unit 122 is used for the purpose according to the invention, as explained below.

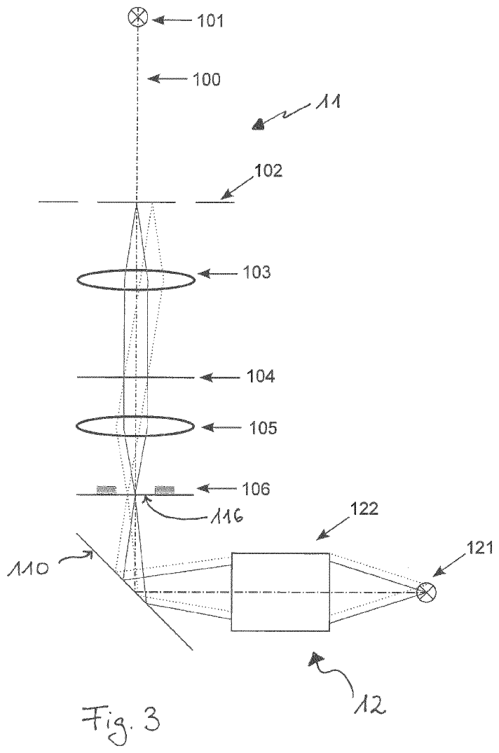

FIG. 3 schematically shows a possible beam path of the fluorescence illumination in the microscope according to FIG. 1. In this respect, the description of the figures in relation to FIG. 1 can be referred to in relation to all details. The imaged beam paths show the beam profiles for a point in the center of the reflected light illumination source 121 and a point at the edge thereof. The focal spot of the reflected light illumination source 121 is imaged into the back focal plane of the objective 105 in each case, the phase ring 106 also being situated in said back focal plane. By way of the objective 105 and the condenser 103, this plane is imaged, in turn, into the back focal plane of the condenser 103, the ring stop 102 being situated in said back focal plane of the condenser. If the imaging is chosen such that the image of the focal spot of the reflected light illumination source 121 is smaller than the diameter of the inner stop region 203 of the ring spot 102, 201 (cf FIG. 2) by way of a suitable setting of the reflected light illumination optical unit 122, the light cone of the reflected light illumination beam path will likewise only strike the inner stop region 203 of the ring stop at the position of the ring stop 102. Consequently, the reflected light illumination optical unit 122 should be set in a suitable embodiment in such a way that the focal spot of the reflected light illumination source 121 substantially falls into the back focal plane of the objective 105. As a person skilled in the art will appreciate, this condition naturally need not be satisfied precisely but only substantially. However, the light cone of the reflected light illumination beam path at the position of the phase ring 106 should preferably be smaller than the diameter of the inner transparent region of said phase ring 106.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10 Microscope
11 Phase contrast transmitted light illumination device
12 Fluorescence reflected light illumination device
100 Transmitted light illumination axis, optical axis
101 Transmitted light illumination source
102 Ring stop
103 Transmitted light illumination optical unit, condenser
104 Object plane
105 Objective
106 Phase ring
110 Beam splitter
116 Inner region of the phase ring
121 Reflected light illumination source
122 Reflected light illumination optical unit
131 Tube
132 Camera
201 Ring stop
202 Ring-shaped region
203 Inner stop region
204 Outer stop region

1. A microscope for examining a sample in phase contrast transmitted light illumination and/or in fluorescence reflected light illumination, the microscope comprising:
a phase contrast transmitted light illumination device comprising a transmitted light illumination source and a transmitted light illumination optical unit with a ring stop, wherein the ring stop comprises a light-opaque inner stop region which is surrounded by an at least partly light-transmissive ring-shaped region;
a fluorescence reflected light illumination device comprising a reflected light illumination source and a reflected light illumination optical unit; and
an objective with a phase ring,
wherein the microscope is configured such that a fluorescence reflected light illumination beam path produced by the fluorescence reflected light illumination device will lie, in terms of its cross section, within the inner stop region of the ring stop of the phase contrast transmitted light illumination device after passing through an object plane of the microscope.

2. The microscope as claimed in claim 1, wherein the transmitted light illumination source comprises or represents a solid-state light source.

3. The microscope as claimed in claim 1, wherein the transmitted light illumination optical unit comprises a condenser, the ring stop being disposed in a back focal plane of the condenser.

4. The microscope as claimed in claim 1, wherein a focal length and/or magnification of the reflected light illumination optical unit is alterable.

5. The microscope as claimed in claim 1, wherein a focal length of the objective is alterable.

6. A method for preventing excitation of a transmitted light illumination source by light of a reflected light illumination source using the microscope according to claim 1, the method comprising:
shielding, by the light-opaque inner stop region of the ring stop, the transmitted light illumination source from the light of the reflected light illumination source.

7. The method as claimed in claim 6, wherein the transmitted light illumination optical unit and/or the reflected light illumination optical unit and/or the objective is/are set in such a way that, in terms of its cross section, the fluorescence reflected light illumination beam path produced by the fluorescence transmitted light illumination device lies within the inner stop region of the ring stop of the phase contrast transmitted light illumination device after passing through the object plane of the microscope.

8. A method for microscope illumination using the microscope as claimed in claim 1, the method comprising:
setting the transmitted light illumination optical unit and/or the reflected light illumination optical unit and/or the objective in such a way that, in terms of its cross section, the fluorescence reflected light illumination beam path produced by the fluorescence reflected light illumination device lies within the inner stop region of the ring stop of the phase contrast transmitted light illumination device after passing through the object plane of the microscope.

9. The method as claimed in claim 8, wherein, in the case of a fixed position of the ring stop on the transmitted light illumination axis and a given setting of the transmitted light illumination optical unit and of the objective, the reflected light illumination optical unit is set in such a way that, in terms of its cross section, the fluorescence reflected light illumination beam path produced by the fluorescence reflected light illumination device lies completely within the inner stop region of the ring stop of the phase contrast transmitted light illumination device after passing through the object plane of the microscope.

10. The method as claimed in claim 9, wherein the reflected light illumination optical unit is set in such a way that the reflected light illumination source is imaged into a back focal plane of the objective within an inner region of said phase ring, the phase ring being disposed in the back focal plane of the objective.
